(19) United States
(12) Patent Application Publication
(10) Pub. No.: US 2016/0103799 A1
(43) Pub. Date: Apr. 14, 2016

(54) METHODS AND SYSTEMS FOR AUTOMATED DETECTION OF PAGINATION

(71) Applicant: Connotate, Inc., New Brunswick, NJ (US)

(72) Inventors: Tianhao Wu, New Brunswick, NJ (US); Vincent Sgro, New Brunswick, NJ (US)

(21) Appl. No.: 14/876,102

(22) Filed: Oct. 6, 2015

Related U.S. Application Data
(60) Provisional application No. 62/061,400, filed on Oct. 8, 2014.

(51) Int. Cl. G06F 17/21; G06F 17/22; G06F 17/27

(52) U.S. Cl. CPC G06F 17/217; G06F 17/2705; G06F 17/2247

(57) ABSTRACT

The present disclosure is directed to methods and systems for monitoring and replaying user interactions with one or more interactive multi-page electronic documents. The methods generally include observing an event consisting of an interaction between a user and a first page of a first instance of an interactive electronic document, identifying a first pagination element in the page, recording data for the event, and using the recorded data to identify, in a second page of a second instance of the interactive electronic document, a second pagination element in the second page, and locating a third page of the second instance of the interactive electronic document based on the second pagination element.

### CROSS-REFERENCE TO RELATED PATENT APPLICATIONS

This application claims priority to U.S. Provisional Application No. 62/061,400, filed Oct. 8, 2014, with the title “Methods and Systems for Automated Detection of Pagination,” which is hereby incorporated by reference in its entirety.

### BACKGROUND

An electronic document is a medium for presenting content. In some instances, the content is divided into multiple presentation elements that can each be considered a page of a multi-page electronic document. Some multi-page electronic documents provide an indicator on each page that indicates where the page fits within the electronic document. Some multi-page electronic documents provide an interactive interface for transitioning presentation of the document from one page to another. However, there is no universal or uniform page indicator or page transition interface. This can make it difficult to identify or reconstruct the content in a multi-page electronic document.

One example of an electronic document is a website, or a portion of a website, where each webpage or frame of the website may be considered a page of the document. Websites are particularly complicated in that each webpage is often constructed from multiple components pulled together when the webpage is requested. In some websites, the content is divided into multiple pages at arbitrary breakpoints, or at breakpoints selected for reasons other than clarity. Further, a pagination component may be included in the resulting webpage that does not reflect the complete page structure of the webpage. These features of websites can make them particularly difficult to parse.

### SUMMARY

In at least one aspect, disclosed is a method for automating user interactions with one or more multi-page interactive electronic documents. The method includes monitoring, by a training module executing on one or more computer processors, interactions between a user and a first interactive electronic document comprising a plurality of elements on two or more pages, the plurality of elements including a pagination element. The method includes identifying, by the training module, characteristics of the pagination element and recording, by the training module, data for recognizing the pagination element based on the identified characteristics. The method further includes generating, by the training module, an automated replay agent capable of using the recorded data to process a second interactive electronic document, identify the pagination element present on a page of the second interactive electronic document, and interact with the pagination element present on the page of the second interactive electronic document to obtain a subsequent page of the second interactive electronic document.

In at least one aspect, disclosed is a system for automating user interactions with one or more multi-page interactive electronic documents. The system includes a computing processor and computer memory storing instructions that, when executed by the processor, cause the process to execute a training module that monitors interactions between a user and a first interactive electronic document comprising a plurality of elements on two or more pages, the plurality of elements including a pagination element. The training module identifies characteristics of the pagination element and records data for recognizing the pagination element based on the identified characteristics. The memory further includes instructions that, when executed by the processor, cause the processor to generate an automated replay agent capable of using the recorded data to process a second interactive electronic document, identify the pagination element present on a page of the second interactive electronic document, and interact with the pagination element present on the page of the second interactive electronic document to obtain a subsequent page of the second interactive electronic document.

In at least some implementations of the methods and systems, the training module uses machine learning to generate the automated replay agent. Some implementations include determining, by the training module, that the pagination element has characteristics substantially similar to a known pagination element in a knowledge base storing a plurality of known pagination element characteristics. Some implementations of the system include a data storage system storing the knowledge base. Some implementations include identifying an interaction between the user and the first interactive electronic document that results in loading a new page of the first interactive electronic document, and identifying, by the training module, from the identified interaction, the pagination element. In some such implementations, the automated replay agent is generated to recreate the identified interaction. Some implementations include parsing a first page of the first interactive electronic document and determining, from the parsing, that the first page includes actionable language for loading additional content. For example, in some such implementations, the actionable language is in Javascript.

### BRIEF DESCRIPTION OF THE DRAWINGS

The following figures are described in detail below:

FIG. 1 is a block diagram of a network environment;

FIG. 2 is a block diagram of an example computing system;

FIG. 3 is an illustration of a display of an example electronic document;

FIG. 4 is an illustration of example pagination components;

FIG. 5 is a flowchart for a method of processing a multi-page electronic document;

FIG. 6 is a flowchart for a method of identifying pagination in an electronic document; and

FIG. 7 is a flowchart for a method of using a pagination component in a multipage interactive electronic document to locate a subsequent page of the multi-page interactive electronic document.

Like reference numbers and designations in the various drawings indicate like elements. For purposes of clarity, not every component may be labeled in every drawing. Drawings are not intended to be drawn to scale.

### DETAILED DESCRIPTION

Electronic documents are generally created for presentation to users. The users can learn, or intuit, how to interact with the document based on the presentation. An automated document processing agent can be created to mimic user interaction with an electronic document. The automated document processing agent can, for example, extract content from an electronic document. Automated document processing agents can be created for specific electronic documents, can be trained to recognize features of a set of electronic documents, or can process an electronic document in an attempt to learn the features of the electronic document based on predetermined document characteristics or patterns. An electronic document may be designed for multi-page presentation. An automated document processing agent can benefit from recognizing that an electronic document spans multiple pages and recognizing how to access the various pages of the electronic document.

User interactions with multi-page interactive electronic documents can be monitored and replayed by an automated document processing agent. Generally, the monitoring includes observing an event consisting of an interaction between a user and a page (a “first page”) of an instance of an interactive electronic document, identifying a pagination element in the page (a “first pagination element”), and recording data for the event. Generally, replaying includes using the recorded data to identify, in a page (a “second page”) of another instance of the interactive electronic document, a pagination element in the second page (a “second pagination element”), and locating a subsequent page (a “third page”) of the second instance of the interactive electronic document based on the second pagination element. Generally, a system monitors a training user's interactions with a document and generates an automated replay agent capable of replaying or recreating those interactions on the document or on similar documents. In some implementations, the replay agent is able to place a document in a desired state and extract information from the document in the desired state. In some implementations, the replay agent is trained to recognize elements, or types of elements, in the document.

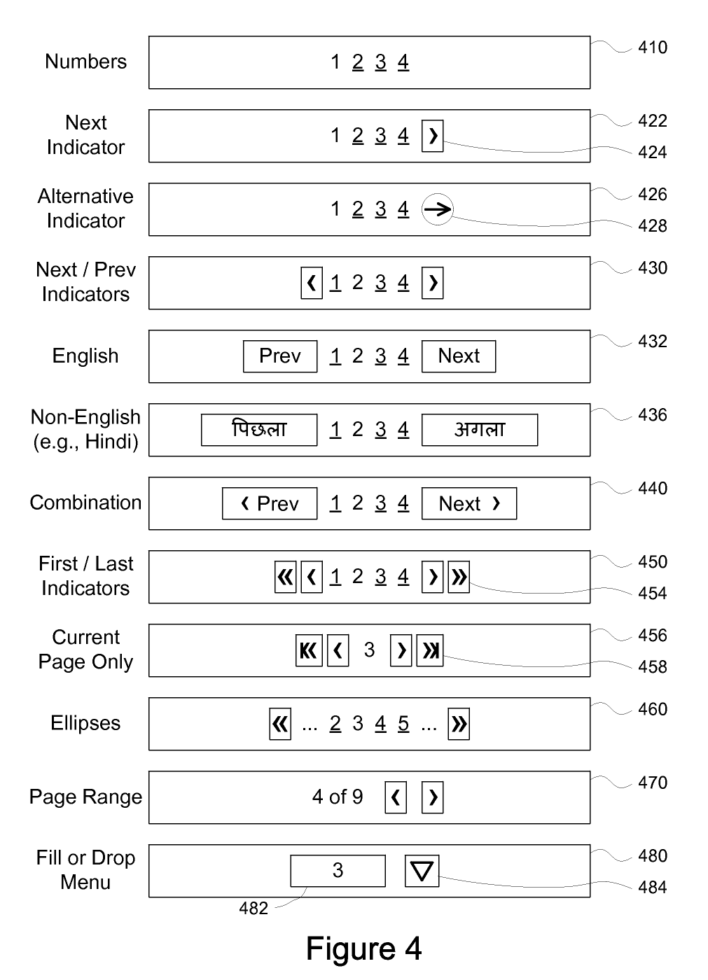

In some implementations, predefined patterns are used to train a machine learning algorithm to automatically figure out which element on a current page of a multi-page electronic document points to the next page, e.g., in a pagination section of the page. If the machine learning approach cannot find the element, user feedback can be used to train the automated document processing agent to recognize a page progression element, e.g., a particular “next” or “next page” link. Examples of pagination components, and of page-link and page-transition interfaces, are described below in reference to FIG. 4.

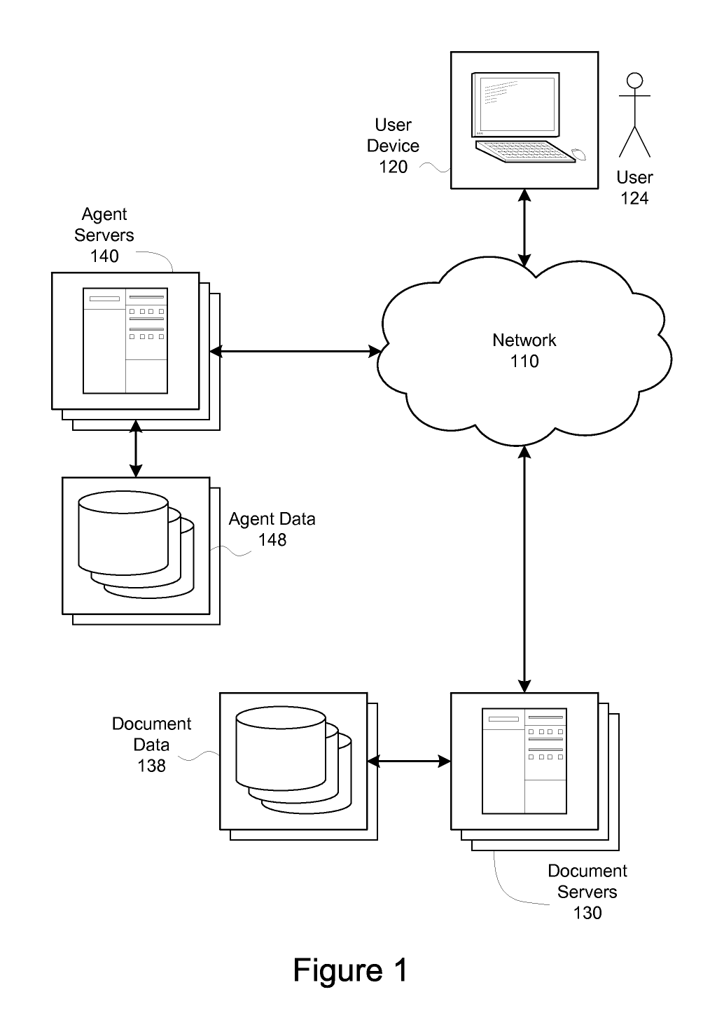

FIG. 1, in broad overview, is a block diagram of a network environment for accessing electronic documents. Illustrated is a network 110 facilitating communication between a user device 120, one or more document servers 130, and one or more agent servers 140. The user device 120 is a device capable of obtaining pages of an electronic document from one or more document servers 130, and presenting the obtained pages to a user 124. The document servers 130 provide the pages of the electronic document from various document data storage systems 138. The agent servers 140 are capable of operating in a manner similar to that of the user device 120 in order to obtain electronic documents from the document servers 130. The agent servers 140 process the obtained electronic documents using agent data stored by agent data storage systems 148. In some implementations, the agent servers 140 store the obtained electronic documents, or content from the obtained electronic documents, in one or more agent data storage systems 148.

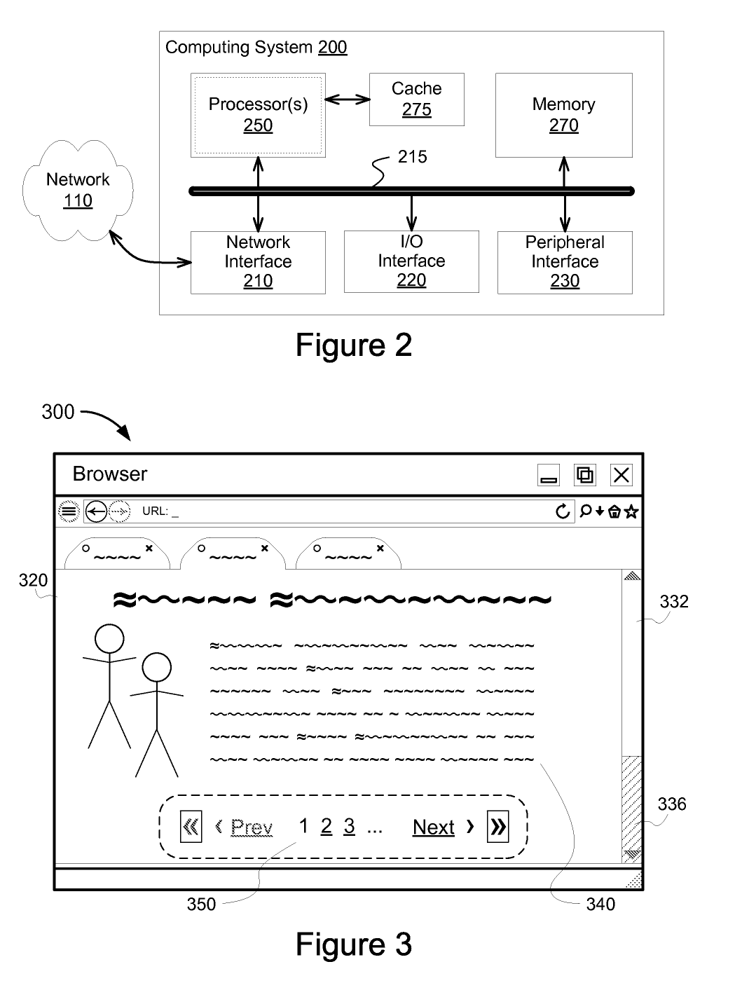

The user device 120 may be any computing device capable of presenting an interactive electronic document to a user 124 and receiving user actions from the user 124. The user device 120 illustrated in FIG. 1 is capable of communication via the network 110. The user device 120 may receive an interactive electronic document from a document server 130, e.g., via the network 110. The user device 120 may host an interactive electronic document locally. As examples, the user device 120 may be a smart phone, a tablet, a laptop, a gaming device, a television set-top box, a personal computer, a desktop computer, a server, or any other computing device. The user device 120 may include an input interface, e.g., a keyboard, a mouse, or a touch screen. The user device 120 may include an output interface, e.g., a screen, a speaker, or a printer. In some implementations, the user device 120 presents the user 124 with an interface in the form of a web browser. In some implementations, the user device 120 is a computing system 200, as illustrated in FIG. 2 and described below.

The user 124 may be any person interacting with a user device 120. For example, the user 124 can be a person wishing to construct or generate an automated document processing agent. The user 124 can train an automated document processing agent, for example, by allowing his or her interactions to be monitored and/or recorded.

The document servers 130 may be any system able to host interactive electronic documents. For example, the document servers 130 illustrated in FIG. 1 provide interactive electronic documents to the user device 120 via a network 110. The document servers 130 may be controlled by a party that is not associated with a person or party creating the automated document processing agent. The document servers 130 may be controlled by a government, a corporation, an academic institution, or any other entity. In some implementations, a document server 130 is a virtual server or service. In some implementations, a document server 130 is operated in a cloud computing environment. In some implementations, a document server 130 is a computing system 200, as illustrated in FIG. 2 and described below.

The document data storage system 138 may be any system for holding interactive electronic document data. The document data storage system 138 may include computer readable media. Examples of computer readable media include, but are not limited to, magnetic media devices such as hard disk drives and tape drives, optical media devices such as CD, DVD, and BluRay® disc drives, read-only or writeable, and semiconductor memory devices such as EPROM, EEPROM, SRAM, and Flash memory devices. In some implementations, the document data storage system 138 hosts a database. In some implementations, the document data storage system 138 uses a structured file system. The document data storage system 138 may be a network attached storage system. The document data storage system 138 may be a storage area network. In some implementations, the document data storage system 138 is co-located with the document servers 130. In some implementations, the document data storage system 138 may be geographically distributed. In some implementations, the document data storage system 138 is a virtual storage system or service, e.g., operated in a cloud computing environment. In some implementations, the document data storage system 138 is a computing system 200, as illustrated in FIG. 2 and described below.

The agent servers 140 may be any system for creating and/or running an automated document processing agent. As an example, an automated document processing agent may be created by monitoring a user device 120 while a user 124 uses the monitored device 120 to interact with one or more document servers 130 and interactive electronic documents served therefrom. In some implementations, a client application is run on the user device 120 to do the monitoring. In some implementations, the agent servers 140 remotely monitor the user interactions. In some implementations, the agent servers 140 store data in an agent data storage system 148, as illustrated in FIG. 1. In some implementations, the agent servers 140 communicate with the data storage system 148 via the network 110. In some implementations, an agent server 140 is a virtual server or service operated in a cloud computing environment. In some implementations, an agent server 140 is a computing system 200, as illustrated in FIG. 2 and described below.

The agent data storage system 148 may be any system for holding interactive electronic document data. The agent data storage system 148 may include computer readable media. Examples of computer readable media include, but are not limited to, magnetic media devices such as hard disk drives and tape drives, optical media devices such as CD, DVD, and BluRay® disc drives, read-only or writeable, and semiconductor memory devices such as EPROM, EEPROM, SRAM, and Flash memory devices. In some implementations, the agent data storage system 148 hosts a database. In some implementations, the agent data storage system 148 uses a structured file system. The agent data storage system 148 may be a network attached storage system. The agent data storage system 148 may be a storage area network. In some implementations, the agent data storage system 148 is co-located with the agent servers 140. In some implementations, the agent data storage system 148 may be geographically distributed. In some implementations, the agent data storage system 148 is a virtual storage system or service, e.g., operated in a cloud computing environment. In some implementations, the agent data storage system 148 is a computing system 200, as illustrated in FIG. 2 and described below.

The network 110 can be a local-area network (LAN), such as a company intranet, a metropolitan area network (MAN), or a wide area network (WAN), such as the Internet and the World Wide Web. The network 110 may be any type and/or form of network and may include any of a point-to-point network, a broadcast network, a wide area network, a local area network, a telecommunications network, a data communication network, a computer network, an asynchronous transfer mode (ATM) network, a synchronous optical network (SONET), a wireless network, an optical fiber network, and a wired network. In some implementations, there are multiple autonomous networks 110 between participants; for example, a smart phone typically communicates with Internet servers via a wireless network connected to a private corporate network connected to the Internet. The network 110 may be public, private, or a combination of public and private networks. The topology of the network 110 may be a bus, star, ring, or any other network topology capable of the operations described herein. The network 110 can be used for communication between the devices 120, 130, and 140 illustrated in FIG. 1.

FIG. 2 is a block diagram of an example computing system 200 suitable for use in implementing the computerized components described herein. The illustrated example computing system 200 includes one or more processors 250 in communication, via a bus 215, with a network interface 210 (in communication with the network 110), an I/O interface 220 (for interacting with a user or administrator), a peripheral interface 230, and a memory device 270. The processor 250 incorporates, or is directly connected to, additional cache memory 275. In some implementations, there are multiple processors 250, cache layers 275, memory devices 270, and/or interfaces 210, 220, and 230. In some uses, additional components are in communication with the computer system 200 via the I/O interface 220 and/or the peripheral interface 230. In some uses, such as in a server context, there is no I/O interface 220 and/or the peripheral interface 230. In some uses, such as in a server context, the I/O interface 220 and/or the peripheral interface 230 is not used. In some implementations, I/O hardware is incorporated into the housing for the computing system 200, e.g., as an attached display, keyboard, speaker, or touch screen, which may be in direct communication with the bus 215, the I/O interface 220, or the peripheral interface 230.

The processor 250 may be any logic circuitry that processes executable instructions, e.g., instructions fetched from the memory 270 or cache 275. In many implementations, the processor 250 is a microprocessor unit, such as the various processors manufactured by Intel Corporation of Mountain View, Calif.; those manufactured by Motorola Corporation of Schaumburg, Ill.; or those manufactured by Advanced Micro Devices of Sunnyvale, Calif. The computing device 200 may be based on any of these processors, or any other processor capable of operating as described herein. The processor 250 may be a single core or multi-core processor. The processor 250 may be multiple processors. The processor 250 may include one or more special purpose co-processors.

The memory device 270 may be any system for holding interactive electronic document data. The memory device 270 may include computer readable media. Examples of computer readable media include, but are not limited to, magnetic media devices such as hard disk drives and tape drives, optical media devices such as CD, DVD, and BluRay® disc drives, read-only or writeable, and semiconductor memory devices such as EPROM, EEPROM, SRAM, and Flash memory devices. The cache memory 275 is a memory device closely associated with, or incorporated into, the processor 250. In some implementations, the cache memory 275 is a high-speed semiconductor memory device such as SRAM, SDRAM, or eDRAM. In some implementations, the cache memory 275 is multi-level and/or hierarchical.

The network interface 210 includes a network controller and one or more interfaces for connection, either physically or by radio waves, to external network devices. The network interface 210 facilitates communication between the computing system 200 and any external network 110. In some implementations, portions of the network interface 210, e.g., the network controller, are implemented in the processor 250.

The I/O interface 220 may support a wide variety of input and/or output devices. Examples of an input device include a keyboard, mouse, touch or track pad, trackball, microphone, touch screen, or drawing tablet. Example of an output device 226 include a video display, touch screen, speaker, Braille display, or printer. Printers include, but are not limited to, inkjet printers, laser printers, pen plotters, dye-sublimation printers, and 3D printers such as stereo-lithographic printers, fused extrusion deposit printers, and laser sintering printers. In some implementations, an input device and/or output device may function as a peripheral device connected via a peripheral interface 230.

A peripheral interface 230 supports connection of additional peripheral devices to the computing system 200. The peripheral devices may be connected physically, as with a FireWire or universal serial bus (USB) device, or wirelessly, as with an ANT+ or Bluetooth device. Examples of peripherals include keyboards, pointing devices, display devices, audio devices, hubs, printers, media reading devices, storage devices, hardware accelerators, sound processors, graphics processors, antennae, signal receivers, global positioning devices, measurement devices, and data conversion devices. In some uses, peripherals include a network interface and connect with the computing system 200 via the network 110 and the network interface 210. For example, a printing device may be a network accessible printer.

The computing system 200 can be any workstation, desktop computer, laptop or notebook computer, server, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein.

In some implementations, one or more of the document servers 130 and/or agent servers 140 illustrated in FIG. 1 are constructed to be similar to the computing system 200 of FIG. 2. In some implementations, a server may be made up of multiple computing systems 200. In some implementations, a server may be a virtual server, for example, a cloud based server. A server as illustrated in FIG. 1 may be made up of multiple computing systems 200 sharing a location or distributed across multiple locations. The multiple computing systems 200 forming a server may communicate using the user-accessible network 110. The multiple computing systems 200 forming a server may communicate using a private network, e.g., a network distinct from the user-accessible network 110 or a virtual private network within the user-accessible network 110.

In some implementations, the user device 120 illustrated in FIG. 1 is constructed to be similar to the computing system 200 of FIG. 2. For example, a user 124 may interact with an input device, e.g., a keyboard, mouse, microphone, or touch screen, to access a web page hosted by an external network device, e.g., a document server 130, via the network 110. The web page information is received at the user's device's network interface 210, and a rendered page is presented to the user 124 via an output device, e.g., a display, screen, touch screen, or speaker. An example display of a web page is illustrated in FIG. 3.

FIG. 3 is an illustration of a user display of an example electronic document. In broad overview, a browser window 300 is illustrated presenting a page 320 of an electronic document, e.g., to a user 124 of a user device 120 as shown in FIG. 1. The browser window 300, as illustrated in FIG. 3, includes a scroll bar 332 with an indicator 336 of a portion of the page 320 not shown. The page 320 includes a content portion 340 and a pagination component 350, illustrated within a dashed-line. Additional examples of pagination components are illustrated in FIG. 4.

Referring to FIG. 3, in more detail, the browser window 300 can be any application for presentation of electronic documents. The browser window 300 illustrated in FIG. 3 is not meant to be any one specific browser. For example, the browser window 300 may be an instance of a browser or reader application such as, but not limited to, Microsoft® Internet Explorer®, Apple® Safari®, Opera™, Google Chrome™, Mozilla Firefox™, Amazon Kindle™, or Amazon Silk™. A user may interact with a browser window 300 by selecting (e.g., clicking on, or using keyboard shortcuts for) various icons or interactive elements. These include, but are not limited to, selecting between multiple tabs, requesting a new electronic document, scrolling through a page presentation from an electronic document, and requesting presentation of another page of an electronic document. In some instances, a multi-page electronic document may include its own pagination component 350.

The browser window 300 presents a rendered version of a page 320 of an electronic document. Electronic documents may be created or structured in a variety of formats, including but not limited to plain text, ePub, XML, HTML, or XHTML. When the browser window 300 receives or obtains an electronic document for presentation, the document is first processed to determine how to present the document content 340, or a portion thereof. In some instances, an electronic document includes instructions, e.g., as embedded metadata, for separately obtaining additional elements to be used in the presentation. Many types of interactive electronic documents can be modeled as a collection of elements. For example, the World Wide Web Consortium (“W3C”) has promulgated the “Document Object Model,” (“DOM”) as a conceptual interface to interactive electronic documents. Using this model, the document elements may be treated as DOM elements forming a data structure, such as a tree hierarchy, regardless of whether the structure is actually present in a rendered version of the document. Additional presentation information may also be included. For example, style information encoded in cascading style sheets (“CSS”) can also be reflected by the DOM and/or by a rendering model for a particular presentation environment. Some web browsers use a render tree to model a web page internally. The render tree may be derived from the DOM and CSS information. In some instances, the render tree includes elements resulting from CSS information that are not present in the DOM. The render tree can, for example, contain specific information regarding the dimensions, positions, and other visual characteristics that each document element will have when rendered to a bitmap or screen. Some web browsers use a render tree to determine which aspects of the resulting bitmap or display require updating when dynamic content or styling information is modified.

The content 340 displayed in the browser window 300 may be a subset of the content of the electronic document. When presentation of an electronic document exceeds the presentation space of the browser window 300, the browser may provide an interface for accessing portions of the electronic document. For example, as shown in FIG. 3, the browser window 300 can include a scroll bar 332 with an indicator 336 of additional document content. A user can interact with the browser window 300 to adjust the presentation, e.g., by interacting with the scroll bar 332 (or using a shortcut key such as the down arrow) to “scroll down” through the document. In some implementations, adjusting the presentation in this manner, or in a similar manner, generates an event that can trigger actionable code in the electronic document. For example, a scrolling event may cause a Javascript or AJAX call to obtain additional content. In some implementations, the additional content may be considered an additional page of the electronic document presented.

Some electronic documents include a pagination component 350. Pagination components provide the user with an interface for moving from page to page within an electronic document. However, there is no one standard pagination component. FIG. 4 illustrates some examples of pagination components, with different common characteristics.

FIG. 4 is an illustration of example pagination components. Examples of pagination components include, but are not limited to, a set of page numbers (component 410); a set of page numbers and an image indicating a next page (components 422 and 426); a set of page numbers and images or text indicating a previous page and a next page (components 430, 432, and 436); a set of page numbers and a combination of text and images indicating a previous page and a next page (component 440); images indicating a first page, a previous page, a next page, and a last page (component 450 and 456); an incomplete set of page numbers, with ellipses, and images indicating a first page and a last page (component 460); a page range and images indicating a previous page and a next page (component 470); and a fill-in menu or a drop-down menu (component 480). Other combinations of these, or other features, are also possible. For example, any element might be replaced with an image or character representation.

Referring to FIG. 4 in more detail, in some example pagination components, the component consists of a set of page numbers, e.g., as shown in example component 410. The page numbers may each be presented as anchored hyperlinks to specific pages of the corresponding multi-page document. In some instances, the current page is shown, but is not a hyperlink.

In some example pagination components, e.g., example components 422 and 426, the component consists of a set of page numbers and an image indicating a next page. Example pagination components 422 and 426 each include page numbers presented as anchored hyperlinks to specific pages of the corresponding multi-page document, as in component 410. Example pagination component 422 also includes a forward indicator 424 of another page. The indicator 424 may be an angle bracket, a chevron, a guillemet, or any other character, image, or symbol suggesting forward pagination. As a second example, the example pagination component 426 includes an encircled arrow as an alternative indicator 428. Although most of the examples in FIG. 4 use angle brackets as a pagination indicator, any icon that is recognizable as a pagination indicator can be used.

In some example pagination components, e.g., example components 430, 332, 436, and 440, the component consists of a set of page numbers and images or text indicating a previous page and a next page. Example pagination components 430, 332, 436, and 440 each include page numbers presented as anchored hyperlinks to specific pages of the corresponding multi-page document, as in component 410. Example pagination component 430 includes a forward indicator, similar to indicator 424 in component 422, and a mirror image reverse indicator. The forward and reverse indicators invite user interaction to progress forward or backwards one page at a time through the multi-page document. In some instances, the forward and reverse indicators are presented in plain text, e.g., shown as “Next” and “Prey” in pagination component 432. The plain text may be in a language consistent with the contextual document, which does not need to be English. For example, the forward and reverse indicators in pagination component 436 are shown in Hindi. In some instances, the forward and reverse indicators use a combination of text and images to indicate a previous page and a next page, e.g., as shown in example pagination component 440.

In some example pagination components, e.g., example components 450 and 456, the component consists of a set of page numbers and images or text indicating jumps to a first page, a previous page, a next page, and a last page. Example pagination component 450 includes page numbers presented as anchored hyperlinks to specific pages of the corresponding multi-page document, as in component 410. Example pagination component 456 does not include page number links, showing only a current page “3.” Example pagination component 450 includes previous and next page indicators, similar to those illustrated in example pagination component 430, and first page and last page indicators 454. First page and last page indicators may be any indicator conveying the concepts of first and last pages, e.g., the double angle brackets illustrated in the last page indicator 454. Other examples of last page indicators include plain text (e.g., “Last”) and an arrow or angle brackets pointed towards a bar (as illustrated in indicator 458).

In some example pagination components, e.g., example component 460, the component consists of a sub-set of the document's page numbers and images or text indicating jumps forward or backward through the multi-page document. Example pagination component 460 includes links to pages two, four, and five of a document containing at least a page one and possibly more than five pages. The component 460 is illustrated as though to appear on the third page of the document, with ellipses before and after the direct page links suggesting the existence of additional pages. In some dynamically generated documents, the exact number of pages is not fixed; thus there could be any number of pages. Example pagination component 460 includes double-guillemet icons indicating forward and backward links, possibly single page transitions, multipage transitions, or transitions to the first and last pages, respectively.

In some example pagination components, e.g., example component 470, the component identifies a page number and page range for the document and includes images or text indicating jumps forward or backward through the multi-page document. Although the illustrated component 470 is shown with single angle bracket icons, suggesting single page transitions, similar pagination components could use other images, text, or icons, and could include first-page/last-page transitions (or chapter-based transitions) as well as the individual page transitions illustrated.

In some example pagination components, e.g., example component 480, the component includes a data-entry field 482 to receive (and show) a requested page number, and a drop-down menu 484 for page selection options. In some instances, a pagination component may include one or both of these interfaces. The example pagination component 480 is included herein to show that a vast variety of pagination components can be encountered, some of which may require more complex interactions for transitions between pages of a multi-page document.

The example pagination components illustrated in FIG. 4 are representative of the various forms and types of possible pagination components, and of the various features that may be combined to form a pagination component. FIG. 4 is not meant to be exhaustive or limiting.

Generally, an automated document processing agent may be constructed that can identify and classify pagination elements in a pagination component for a multi-page document. In some implementations, the element is a DOM element. In some implementations, the element is a render tree element. In some implementations, the element is an element for a generalized model of an interactive electronic document. In some implementations, an automated document processing agent is trained using a training document. An agent customer initializes a new automated document processing agent that will be used to process documents that are structured similarly to the training document. The training process executes a first pass over the training document and detects common elements. Information about the common elements detected forms a starting point for creating the automated document processing agent. The training process then observes interaction between the agent customer and the training document to refine the information and train the agent. For example, a machine learning module may be trained by a user in this manner to recognize elements of an interactive electronic document. Once trained, the machine learning module may then be used to identify similar elements in other documents. In some implementations, the other documents may be significantly different from the training document. In some implementations, a similar approach is used in the training itself.

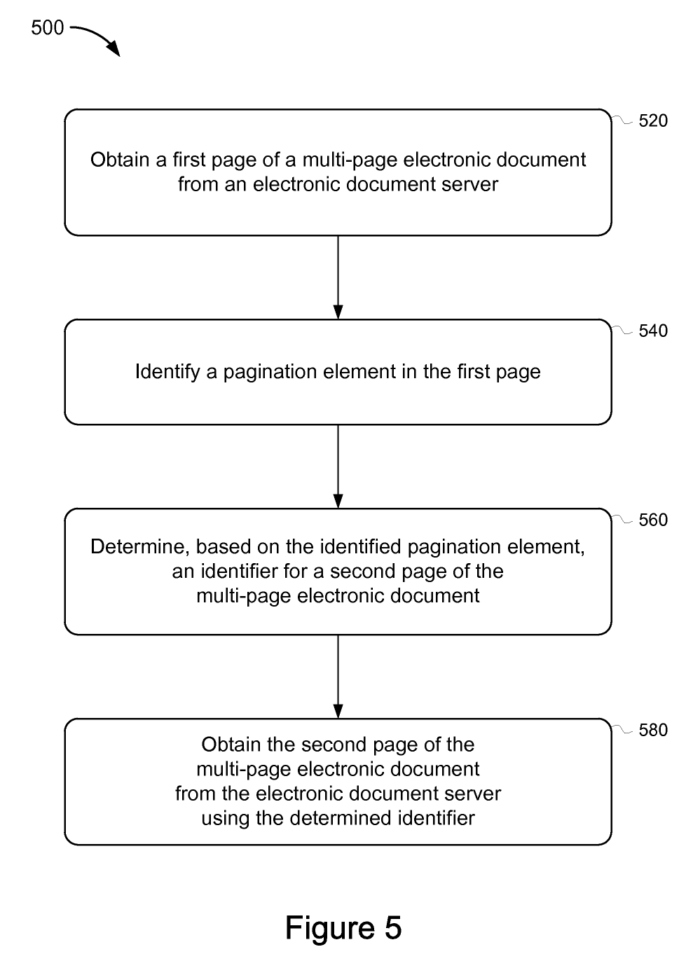

FIG. 5 is a flow diagram for a method 500 used by an automated document processing agent to obtain multiple pages of a multi-page interactive electronic document. An automated document processing agent obtains a first page (i.e., any arbitrary page) of a multi-page electronic document from an electronic document server (stage 520) and identifies a pagination element in the first page (stage 540). The automated document processing agent then determines, based on the identified pagination element, an identifier for a second page of the multi-page electronic document (stage 560) and obtains the second page (i.e., another page) of the multi-page electronic document from the electronic document server using the determined identifier (stage 580). The first page and the second page are different pages of the multi-page electronic document, but are not necessarily a specific “page 1” and “page 2.” The first and second pages (as used in this description here) refer to any two pages of the document.

Referring to FIG. 5 in more detail, the method 500 begins with an automated document processing agent obtaining a first page of a multi-page electronic document from an electronic document server (stage 520). In a first iteration of the method 500, the “first page” may be a gateway page or initial page of the multi-page document. On subsequent iterations, the “first page” may be another page deeper into the document. The automated document processing agent obtains the page using any appropriate method, including but not limited to those described herein. In some implementations, the multi-page electronic document is a series of web pages and the automated document processing agent obtains each page using an HTTP or HTTPS request, e.g., HTTP GET or HTTP POST. In some implementations, the agent constructs the W3C document object model (“DOM”) and parses the DOM tree to process the document page contents.

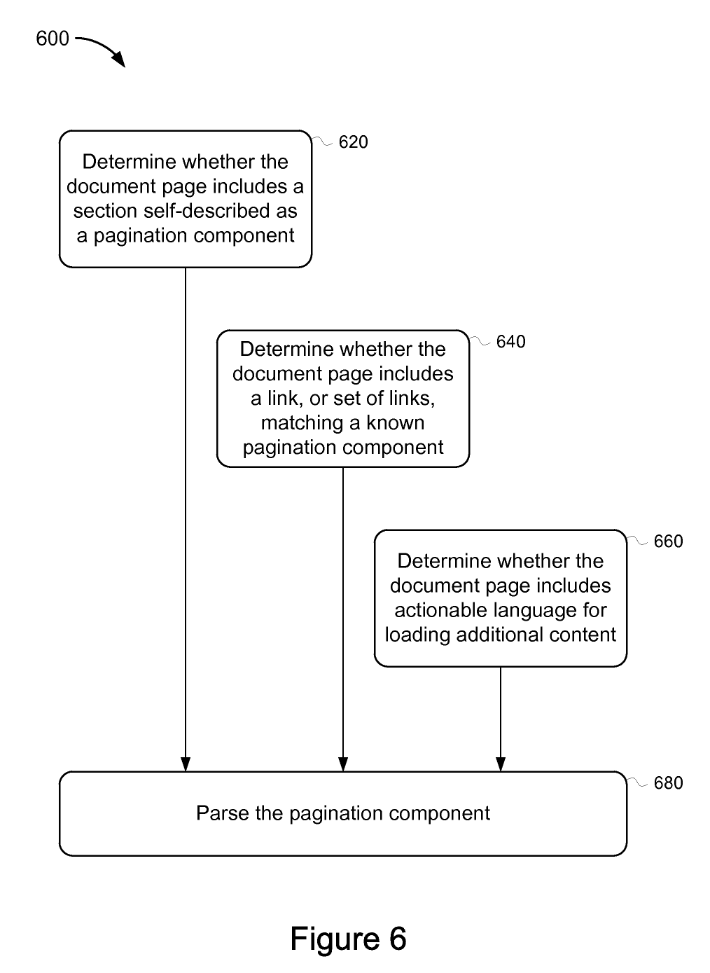

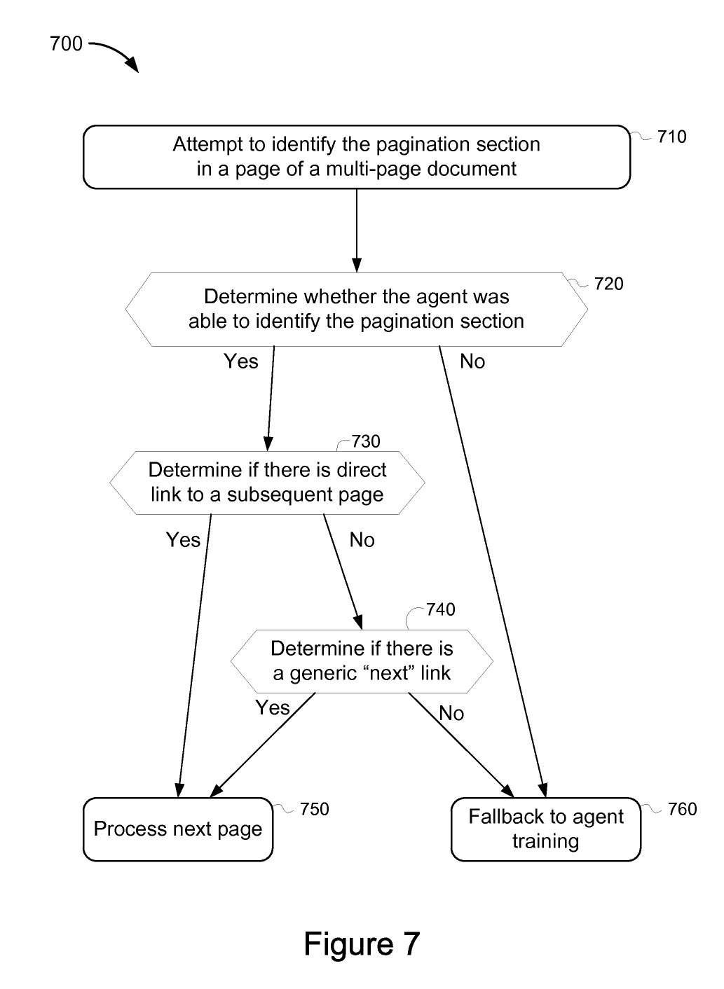

The automated document processing agent then identifies a pagination element in the first page (stage 540). In some implementations, the automated document processing agent compares elements to a database of known pagination element features, e.g., features as described in reference to FIG. 4. In some implementations, the agent identifies the pagination element as an element similar to an expected pagination element in accordance with previous training of the agent. In some implementations, the automated document processing agent fails to identify an element sufficiently similar to an expected pagination element, and identifies an unexpected element that corresponds to an element in the database of known pagination element features. Detailed methods for identifying a pagination element are described below in reference to FIGS. 6 and 7.

The automated document processing agent determines, based on the identified pagination element, an identifier for a second page of the multi-page electronic document (stage 560). In some implementations, the pagination element includes a network address such as a uniform resource identifier (URI) or uniform resource locator (URL) identifying one or more additional pages of the multi-page document. For example, a given first page of the document may include hyperlinks to one or more pages in addition to the given first page. In some implementations, the hyperlink includes a query portion that specifies the destination page by name or number. For example, an identifier for a page may be in the form: “http://www.domain.example/sitename/fetch.pl?page=4” where the “page=4” portion is a query for page four. A pattern, e.g., “/page=[0-9]+/”, may be used to identify the page number portion and another page may be fetched using an alternative identifier with a different page number, e.g., ““http://www.domain.example/sitename/fetch.pl?page=7”. In some implementations, the automated document processing agent identifies multiple additional pages and sorts the additional pages into an ordering. In some implementations, the identifier for the second page provides information required to access the second page, e.g., via a page fetch. In some implementations, the identifier is a URL. In some implementations, the identifier is a label stored in association with a URL. In some implementations, the identifier identifies a page object that, when subjected to an interaction, will lead to the identified page. An interaction may include, for example, a click, a selection, a hover, or any form of interaction or manipulation. In some implementations, the identifier identifies actionable language for loading the identified page. The actionable language may be, for example, a script or portion of a script, e.g., written in Java or Javascript. The automated document processing agent then obtains each of the additional pages. In some implementations, the automated document processing agent then obtains the additional pages in sequential order. In some implementations, the automated document processing agent then obtains the additional pages in an arbitrary order, e.g., only obtaining pages that have been added since a previous visit, obtaining random pages, obtaining the pages in reverse order, and so forth.

The automated document processing agent then obtains the second page (i.e., another page) of the multi-page electronic document from the electronic document server using the determined identifier (stage 580).

FIG. 6 is a flow diagram for a method 600 used by an automated document processing agent to identify a pagination component in a multi-page interactive electronic document. The method 600 begins after an automated document processing agent has obtained a page of a multi-page electronic document from an electronic document served. The automated document processing agent determines whether the document page includes a section self-described as a pagination component (stage 620) and/or whether the document page includes a link, or set of links, that matches a known pagination component (stage 640). The automated document processing agent may also determine whether the document page includes any actionable language for loading additional content (stage 660). Once the automated document processing agent has identified a pagination component in one or more of stages 620, 640, and 660, the automated document processing agent parses the pagination component in the obtained document page to identify additional pages of the document (stage 680).

Referring to FIG. 6 in more detail, the automated document processing agent determines whether the document page includes a section self-described as a pagination component (stage 620). For example, a document may include a dedicated pagination section (e.g., a “DIV” section set off from the rest of the document by “DIV” mark-up tags) labeled as such. The label may be either within displayed content or within hidden metadata-type content, e.g., embedded in a DIV tag or SPAN tag. In some instances, a pagination section may be labeled, for example, “Pages,” “Navigation,” “Pagination,” “Next,” “Index,” or “Contents.”

The automated document processing agent determines whether the document page includes a section with a link, or set of links, that matches a known pagination component (stage 640). For example, referring to FIG. 1, in some implementations, the agent data 148 includes a database of known pagination components and component elements, e.g., as described in reference to FIG. 4. The automated document processing agent determines if a page includes elements that are similar to those in the database of known pagination components.

Referring still to FIG. 6, the automated document processing agent determines whether the document page includes any actionable language for loading additional content (stage 660). It is also possible for a multi-page interactive electronic document to transition between pages based on user actions without presentation of a pagination component. Thus, in some implementations, the automated document processing agent determines whether the document page includes any actionable language for loading additional content at stage 660. One example of such language is scripting code activated by a user scrolling action, e.g., causing additional content to be fetched when the user scrolls to the bottom of the page presented. This example is referred to as “Get More.” Another example is scripting code activated by mouse placement at an edge of the content display, e.g., causing display of arrows or other pagination features that are otherwise hidden from the user.

Once the automated document processing agent has identified a pagination component in one or more of stages 620, 640, and 660, the automated document processing agent parses the pagination component in the obtained document page to identify additional pages of the document (stage 680). In some implementations, identifications from one or more of stages 620, 640, and 660 are combined to form a composite identification.

FIG. 7 is a flow diagram for a method 700 used by an automated document processing agent to follow a pagination component in a multi-page interactive electronic document to a subsequent page of the multi-page interactive electronic document. The method 700 begins after an automated document processing agent has obtained a page of a multi-page electronic document from an electronic document served. The automated document processing agent attempts to identify the pagination section (stage 710). The automated document processing agent determines whether the agent was able to identify the pagination section (stage 720) and, if so, determines if there is a direct link in the pagination section to a subsequent page of the multi-page interactive electronic document (stage 730). If there is no direct link, the automated document processing agent determines whether there is a more generic “next” link (stage 740). If there is a direct link or a generic “next” link, the automated document processing agent follows the link and processes the next page (stage 750). If there is no pagination section, no direct link, and no generic “next” link, then the automated document processing agent uses its alternative methods of parsing the page and attempting to identify any subsequent pages based on previous training (stage 760).

Referring to FIG. 7 in more detail, the automated document processing agent attempts to identify the pagination section (stage 710). In some implementations, the automated document processing agent uses the method 600, described in reference to FIG. 6, to attempt to identify the pagination section in a page of a multi-page document. In some implementations, the automated document processing agent uses a method similar to the method 600, omitting one or more of the stages illustrated in FIG. 6. In some implementations, the automated document processing agent attempts to identify the pagination section in a page based on previous training sessions.

Still referring to FIG. 7, the automated document processing agent determines whether the agent was able to identify the pagination section (stage 720) and, if so, determines if there is a direct link in the pagination section to a subsequent page of the multi-page interactive electronic document (stage 730). For example, referring to FIG. 4, example pagination component 410 includes four page numbers (1, 2, 3, 4), of which three of the page numbers are underlined. Underlining is a common presentation mechanism in web pages to indicate that the underlined item is a hyperlink to another web page. The example pagination component 410 may therefore indicate direct links to pages two, three, and four, from a presented page one. The automated document processing agent, in parsing the page (e.g., processing the W3C DOM render tree for the page), may identify a pagination section (in stage 710) that includes direct links to a next page (e.g., as described in relation to example pagination component 410, or in any other style of pagination component including, but not limited to, the other example pagination components illustrated in FIG. 4). The automated document processing agent determines (in stage 730) that the identified pagination component includes a direct hyperlink to the next page in a series of pages for a multi-page electronic document. In some implementations, the automated document processing agent identifies a next page link without identifying a specific pagination section.

Referring still to FIG. 7, the automated document processing agent determines whether the agent was able to identify the pagination section (stage 720) and, if there is no direct link, the automated document processing agent determines whether there is a more generic “next” link (stage 740). A generic “next” link is a link to a page subsequent to the page currently being processed. The link may be rendered with text such as “Next,” “Next Page,” “More,” or “Continue.” The text may be in the same language as the page being rendered, or may be in another language. The link may be rendered with an icon or image recognizable as a generic “next” link, such as a chevron, guillemet, or angle bracket. The link may be labeled with some combination of text and image. For example, without limitation, referring to FIG. 4, example pagination components 430, 432, 436, 440, 450, 456, and 470 each include examples of a generic “next” link. In some implementations, the automated document processing agent identifies a link as a “next” page link based on the destination of the link. For example, if a link points to a URL identical to the URL for the present page, except as to one numeric portion, this may suggest a subsequent page of a multi-page document and thus be a “next” page link. E.g., it the numeric portion is one greater than a similar numeric portion in the URL for the present page, the link may be to the subsequent page.

If there is a direct link or a generic “next” link, the automated document processing agent follows the link and processes the next page (stage 750). In situations where the automated document processing agent identifies a specific pagination section matching a known pagination section structure, the agent can use information about the known pagination section structure to identify a page link within the pagination section. In some implementations, the pagination section of a multi-page interactive electronic document may obscure the individual page links, but the overall set of pagination links may still resemble a known pagination section such that the automated document processing agent can be trained to recognize the section and locate a link to the next page.

If there is no pagination section, no direct link, and no generic “next” link, then the automated document processing agent uses its alternative methods of parsing the page and attempting to identify any subsequent pages based on previous training (stage 760). That is, if the automated document processing agent is unable to identify a pagination section (determined at stage 720), and unable to identify a direct link to a next page (determined at stage 730), and unable to identify a generic link to a next page (determined at stage 740), then the automated document processing agent is unable to process a pagination section. However, the agent still processes the document in accordance with other document processing features of the agent.

It should be understood that the systems and methods described above may be provided as instructions in one or more computer programs recorded on or in one or more articles of manufacture, e.g., computer-readable media. The article of manufacture may be a floppy disk, a hard disk, a CD-ROM, a flash memory card, a PROM, a RAM, a ROM, or a magnetic tape. In general, the computer programs may be implemented in any programming language, such as LISP, Perl, Python, Ruby, C, C++, C#, PROLOG, or in any byte code language such as JAVA. The software programs may be stored on or in one or more articles of manufacture as object code.

Having described certain implementations of methods and systems, it will now become apparent to one of skill in the art that other implementations incorporating the concepts of the disclosure may be used. Therefore, the disclosure should not be limited to certain implementations, but rather should be limited only by the spirit and scope of the following claims.

What is claimed is:

1. A method of automating user interactions with one or more multi-page interactive electronic documents, the method comprising:
monitoring, by a training module executing on one or more computer processors, interactions between a user and a first interactive electronic document comprising a plurality of elements on two or more pages, the plurality of elements including a first pagination element;
identifying, by the training module, characteristics of the first pagination element;
recording, by the training module, data for recognizing the first pagination element based on the identified characteristics; and
generating, by the training module, an automated replay agent capable of using the recorded data to process a second interactive electronic document, identify a second pagination element present on a page of the second interactive electronic document, the second pagination element corresponding to the first pagination element, and interact with the second pagination element present on the page of the second interactive electronic document to obtain a subsequent page of the second interactive electronic document.

2. The method of claim 1, wherein the training module uses machine learning to generate the automated replay agent.

3. The method of claim 1, comprising determining, by the training module, that the first pagination element has characteristics substantially similar to a known pagination element in a knowledge base storing a plurality of known pagination element characteristics.

4. The method of claim 1, comprising:
identifying an interaction between the user and the first interactive electronic document resulting in loading a new page of the first interactive electronic document, and identifying, by the training module, the first pagination element based on the identified interaction resulting in loading the new page of the first interactive electronic document.

5. The method of claim 4, comprising generating the automated replay agent to recreate the identified interaction.

6. The method of claim 1, comprising parsing a first page of the first interactive electronic document and determining, from the parsing, that the first page includes actionable language for loading additional content.

7. The method of claim 6, wherein the actionable language is in Javascript.

8. The method of claim 1, wherein the identified characteristics of the first pagination element include one or more of: a set of page numbers, a next page image, a previous page image, a first page image, or a last page image.

9. A system for automating user interactions with one or more multi-page interactive electronic documents, the system comprising one or more computer processors configured to execute instructions, wherein the instructions, when executed by the one or more computer processors, cause the one or more computer processors to:
monitor interactions between a user and a first interactive electronic document comprising a plurality of elements on two or more pages, the plurality of elements including a first pagination element;
identify characteristics of the first pagination element;
record data for recognizing the first pagination element based on the identified characteristics; and
generate an automated replay agent capable of using the recorded data to process a second interactive electronic document, identify a second pagination element present on a page of the second interactive electronic document, the second pagination element corresponding to the first pagination element, and interact with the second pagination element present on the page of the second interactive electronic document to obtain a subsequent page of the second interactive electronic document.

10. The system of claim 9, wherein the instructions cause the one or more processors to use machine learning to generate the automated replay agent.

11. The system of claim 9, further comprising a knowledge base storing a plurality of known pagination element characteristics, wherein the instructions, when executed by the one or more computer processors, cause the one or more computer processors to determine that the first pagination element has characteristics substantially similar to a known pagination element in the knowledge base.

12. The system of claim 9, wherein the instructions, when executed by the one or more computer processors, cause the one or more computer processors to:
identify an interaction between the user and the first interactive electronic document resulting in loading a new page of the first interactive electronic document, and identify the first pagination element based on the identified interaction resulting in loading the new page of the first interactive electronic document.

13. The system of claim 12, wherein the instructions, when executed by the one or more computer processors, cause the one or more computer processors to generate the automated replay agent to recreate the identified interaction.

14. The system of claim 9, wherein the instructions, when executed by the one or more computer processors, cause the one or more computer processors to parse a first page of the first interactive electronic document and determine, from the parsing, that the first page includes actionable language for loading additional content.

15. The system of claim 14, wherein the actionable language is in Javascript.

16. The system of claim 9, wherein the identified characteristics of the first pagination element include one or more of: a set of page numbers, a next page image, a previous page image, a first page image, or a last page image.

17. A computer-readable medium storing non-transitory instructions that, when executed by a computer processor, cause the computer processor to:
monitor interactions between a user and a first interactive electronic document comprising a plurality of elements on two or more pages, the plurality of elements including a first pagination element;
identify characteristics of the first pagination element;
record data for recognizing the first pagination element based on the identified characteristics; and
generate an automated replay agent capable of using the recorded data to process a second interactive electronic document, identify a second pagination element present on a page of the second interactive electronic document, the second pagination element corresponding to the first pagination element, and interact with the second pagination element present on the page of the second interactive electronic document to obtain a subsequent page of the second interactive electronic document.

18. The computer-readable medium of claim 17, wherein the instructions, when executed by the computer processor, cause the computer processor to determine that the first pagination element has characteristics substantially similar to a known pagination element in a knowledge base storing a plurality of known pagination element characteristics.

19. The computer-readable medium of claim 17, wherein the instructions, when executed by the computer processor, cause the computer processor to:
identify an interaction between the user and the first interactive electronic document resulting in loading a new page of the first interactive electronic document;
identify the first pagination element based on the identified interaction resulting in loading the new page of the first interactive electronic document; and
generate the automated replay agent to recreate the identified interaction.

20. The computer-readable medium of claim 17, wherein the instructions, when executed by the computer processor, cause the computer processor to parse a first page of the first interactive electronic document and determine, from the parsing, that the first page includes actionable language for loading additional content.
